(19) United States
(12) Patent Application Publication
(10) Pub. No.: US 2026/0202791 A1
(43) Pub. Date: Jul. 16, 2026

(54) FIXING DEVICE CAPABLE OF FIXING IMAGE ON RECORDING MEDIUM AND IMAGE FORMING APPARATUS WITH FIXING DEVICE

(71) Applicant: KYOCERA Document Solutions Inc., Osaka (JP)

(72) Inventor: Hiroki KAWASAKI, Osaka (JP)

(73) Assignee: KYOCERA Document Solutions Inc., Osaka (JP)

(21) Appl. No.: 19/441,119

(22) Filed: Jan. 6, 2026

(30) Foreign Application Priority Data
Jan. 10, 2025 (JP) 2025-004186

(51) Int. Cl. G03G 21/20; G03G 15/00; G03G 15/20

(52) U.S. Cl. CPC G03G 21/206; G03G 15/2028; G03G 15/2064; G03G 15/657; G03G 2215/00413; G03G 2215/2025; G03G 2221/1639; G03G 2221/1645

(57) ABSTRACT

A fixing device includes a heat roller, a heating device, a pressure roller, a conveyance guide, and an air blower. The heating device is disposed inside the heat roller to heat the heat roller. The pressure roller is opposed to the heat roller and forms, together with the heat roller, a nip where a recording medium to be subjected to fixing processing is to be passed through. The conveyance guide guides the recording medium to the nip and is provided with a gap from the pressure roller in a direction in which the conveyance guide guides the recording medium. The air blower is disposed in a region located on the pressure roller side of the conveyance guide in a direction of alignment of the heat roller and the pressure roller and blows air toward the heat roller through the gap between the pressure roller and the conveyance guide.

### INCORPORATION BY REFERENCE

This application claims priority to Japanese Patent Application No. 2005-004186 filed on January 10, 2025, the entire contents of which are incorporated by reference herein.

### BACKGROUND

The present disclosure relates to fixing devices that fix images formed on recording media to the recording media by thermal pressure fixing and image forming apparatuses equipped with the fixing devices.

An electrophotographic image forming apparatus includes a fixing device that fixes a toner image transferred to a recording medium. There is a general fixing device including: a heat roller equipped with a heating member and a heating device that heats the heating member; a pressure roller opposed to the heat roller and forming, together with the heat roller, a nip where a recording medium to be subjected to fixing processing is to be passed through; and a conveyance guide that guides the recording medium to the nip and is provided to form a gap from the pressure roller in a direction of guidance of the recording medium, wherein a toner image is fixed on the recording medium by the application of heat and pressure (thermal pressure fixing) at the nip.

In an image forming apparatus including a fixing device in which a heat roller makes contact with a recording medium, when, for example, it continuously makes prints on small-sized recording media, regions of the heat roller where the recording media have not passed on (non-sheet-passing regions) are increased in temperature. Therefore, the image forming apparatus includes an air blower that blows air toward the heat roller.

Such an image forming apparatus equipped with a general air blower includes an end temperature-increase cooling device disposed toward the side of the recording medium where the heat roller exists and capable of cooling the ends of the heat roller, wherein the end temperature-increase cooling device includes end cooling ducts and cooling fans provided near both ends of the heat roller in a direction orthogonal to the direction of conveyance of the recording medium. When small-sized recording media continuously pass through the nip formed by the heat roller and the pressure roller, the end temperature-increase cooling device blows air to the heat roller to cool the non-sheet-passing regions of the heat roller and thus suppresses the temperature increase of the regions.

In this end temperature-increase cooling device, duct shutters are disposed inwardly of the respective cooling ducts and the air blowing width of each air blow port in the direction orthogonal to the direction of conveyance of the recording medium can be changed by moving the associated duct shutter. By adjusting the air blowing width to fit the width of the associated non-sheet-passing region, the temperature increase of the non-sheet-passing regions can be suppressed while a region of the heat roller where the recording medium passes on (a sheet passing region) is prevented from being cooled.

### SUMMARY

A technique improved over the aforementioned techniques is proposed as one aspect of the present disclosure.

A fixing device according to an aspect of the present disclosure includes a heat roller, a heating device, a pressure roller, a conveyance guide, and an air blower. The heating device is disposed inside the heat roller to heat the heat roller. The pressure roller is opposed to the heat roller and forms, together with the heat roller, a nip where a recording medium to be subjected to fixing processing is to be passed through. The conveyance guide guides the recording medium to the nip and is provided with a gap from the pressure roller in a direction in which the conveyance guide guides the recording medium. The air blower is disposed in a region located on the pressure roller side of the conveyance guide in a direction of alignment of the heat roller and the pressure roller and blows air toward the heat roller through the gap between the pressure roller and the conveyance guide.

An image forming apparatus according to another aspect of the present disclosure includes an image forming device and the fixing device. The image forming device forms a toner image. The fixing device fixes the toner image formed by the image forming device onto a surface of the recording medium.

### BRIEF DESCRIPTION OF THE DRAWINGS

FIG. 1 is a cross-sectional view showing the structure of an image forming apparatus including a fixing device according to an embodiment of the present disclosure.

FIG. 2 is a functional block diagram showing an electrical configuration of the image forming apparatus shown in FIG. 1.

FIG. 3 is a cross-sectional view showing the structure of the fixing device shown in FIG. 1.

FIG. 4 is a schematic view showing the structure of the fixing device shown in FIG. 3.

FIG. 5 is a schematic view showing the size of a heating device included in the fixing device shown in FIG. 3.

FIG. 6 is a graph schematically showing a temperature distribution of a heat roller included in the fixing device shown in FIG. 3.

FIG. 7 is a flowchart showing control processing of a controller shown in FIG. 2.

### DETAILED DESCRIPTION

Hereinafter, a description will be given of a fixing device according to an embodiment as an aspect of the present disclosure and an image forming apparatus including the fixing device with reference to the drawings.

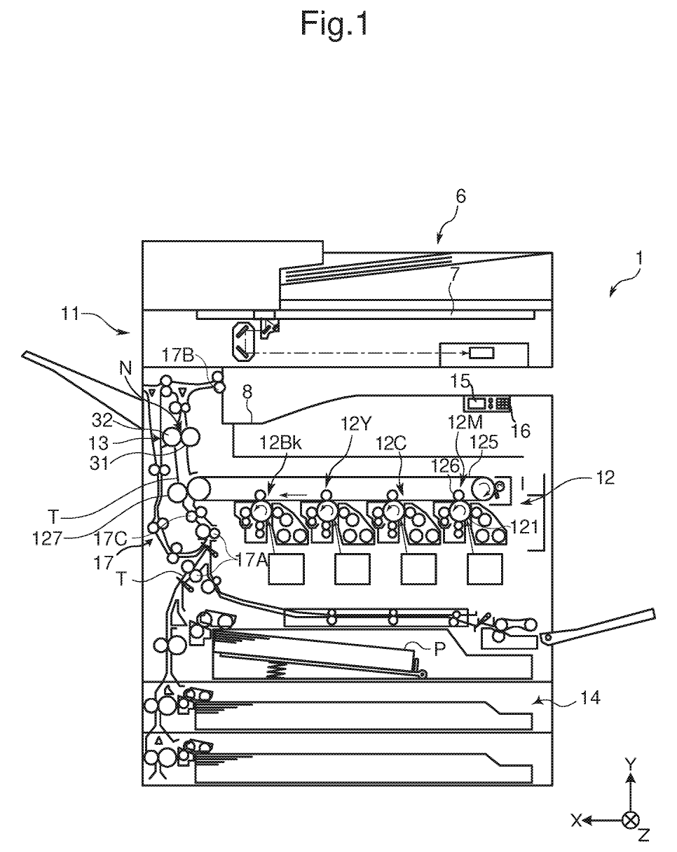

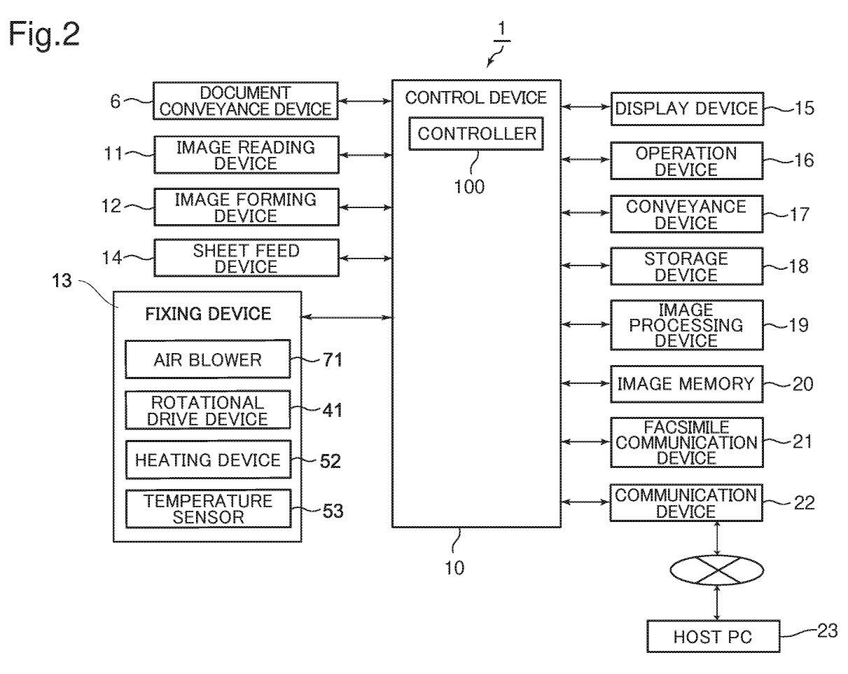

FIG. 1 is a cross-sectional view showing the structure of an image forming apparatus 1 including a fixing device 13 according to an embodiment of the present disclosure. FIG. 2 is a functional block diagram showing an electrical configuration of the image forming apparatus 1 shown in FIG. 1. The image forming apparatus 1 is a multifunction peripheral having multiple functions including, for example, a copy function, a transmission function, a print function, and a facsimile function.

As shown in FIG. 1, the image forming apparatus 1 includes a document conveyance device 6, a document reading device 11, an image forming device 12, a fixing device 13, a sheet feed device 14, a display device 15, an operation device 16, and a conveyance device 17.

The document conveyance device 6 conveys sheets of original document placed on a document loading table sheet by sheet to a reading position of the image reading device 11. The document conveyance device 6 is designed to be pivotally movable up and down about a horizontal pivot shaft located to the back side of the plane of FIG. 1 to make a platen glass 7 open and closed. The document conveyance device 6 functions also as a cover that holds down a sheet of original document on the platen glass 7.

The image reading device 11 is a scanner that optically reads a sheet of original document and generates image data representing an image of the sheet of original document. The image reading device 11 reads a sheet of original document conveyed by the document conveyance device 6 or a sheet of original document placed on the platen glass 7.

The image forming device 12 includes a photosensitive drum, a charging device, an exposure device, a developing device, and a transfer device. The exposure device includes an LSU (laser scanning unit). The image forming device 12 forms, based on the image data, a toner image on a sheet P being conveyed along a conveyance path T by the conveyance device 17. In making a multicolor print, an image forming unit 12M for magenta, an image forming unit 12C for cyan, an image forming unit 12Y for yellow, and an image forming unit 12Bk for black, all included in the image forming device 12, form respective toner images of magenta, cyan, yellow, and black on their respective photosensitive drums 121 through charging, exposure, and development processes. The respective toner images of the four colors formed in this manner are transferred to an intermediate transfer belt 125 by respective primary transfer rollers 126 and thus layered one on top of another to become a multicolor toner image. The layered multicolor toner image is further transferred, by a secondary transfer roller 127, to a sheet P being conveyed in the conveyance path T. In making a black-and-white print, the image forming unit Bk for black of the image forming device 12 forms a black toner image on its photosensitive drum 121 through the charging exposure, and development processes. The black toner image formed in this manner is transferred to the intermediate transfer belt 125 by its primary transfer roller 126. The black-and-white toner image transferred to the intermediate transfer belt 125 is further transferred, by the secondary transfer roller 127, to a sheet P being conveyed in the conveyance path T.

The fixing device 13 applies heat and pressure to the sheet P with the toner image formed thereon to fix the toner image onto the sheet P. The sheet P with the toner image fixed thereon is ejected to a sheet output tray 8.

The sheet feed device 14 includes a manual feed tray and a plurality of sheet feed cassettes. The sheet feed device 14 pulls out sheets P contained in any one of the plurality of sheet feed cassette or sheets P placed on the manual feed tray sheet by sheet by a pick-up roller and feeds them to the conveyance path T. The sheet P is not limited to a paper medium and may be, for example, an OHP (overhead projector) sheet. The sheet P and the OHP sheet are examples of the recording medium defined in CLAIMS.

The display device 15 includes a liquid crystal display or an organic EL (organic light-emitting diode) display. The display device 15 displays various screen images. The operation device 16 include a plurality of hardware keys, such as a Start key for use in entering an instruction to start execution of copy processing, scan processing or other types of processing, and a touch panel disposed over the display device 15. The operation device 16 accepts an input of an instruction from a user.

The conveyance device 17 includes a conveyance roller pair 17A, an ejection roller pair 17B, a registration roller pair 17C, other roller pairs, and a conveyance motor. When the conveyance motor drives to rotate the conveyance roller pair 17A, the ejection roller pair 17B, the registration roller pair 17C, and the other roller pairs, the sheet P fed by the sheet feed device 14 is conveyed along the conveyance path T to the image forming device 12, the fixing device 13, and so on.

As shown in FIG. 2, the image forming apparatus 1 further includes a control device 10, a storage device 18, an image processing device 19, an image memory 20, a facsimile communication device 21, and a communication device 22.

The control device 10 is electrically connected to the document conveyance device 6, the document reading device 11, the image forming device 12, the fixing device 13, the sheet feed device 14, the display device 15, the operation device 16, the conveyance device 17, the storage device 18, the image processing device 19, the image memory 20, the facsimile communication device 21, and the communication device 22.

The control device 10 controls the operations of the components of the image forming apparatus 1.

The storage device 18 is a large-capacity storage device, such as an HDD (hard disk drive) or an SSD (solid state drive), for use in storing various types of data and holds various types of computer programs, such as various types of control programs for use in implementing the operations of the image forming apparatus 1.

The image processing device 19 applies image processing (such as rasterization processing, color conversion processing, rotation and aggregation processing, resolution conversion processing, and screen processing) to image data. The image memory 20 temporarily stores image data. The facsimile communication device 21 sends and receives image data via public lines. The communication device 22 includes a communication module, such as a LAN (local area network) board. The control device 10 performs data communication through the communication device 22 with external devices, such as a host PC (personal computer) 23, connected to a network.

The control device 10 includes a processor, a RAM (random access memory), a ROM (read only memory), and so on. The processor is, for example, a CPU (central processing unit), an MPU (micro processing unit) or an ASIC (application specific integrated circuit).

When the control program or the like stored in the above ROM or the storage device 18 is executed by the above processor, the control device 10 functions as a controller 100 that controls the operations of the document conveyance device 6, the document reading device 11, the image forming device 12, the fixing device 13, the sheet feed device 14, the display device 15, the operation device 16, the conveyance device 17, and so on. The fixing device 13 and part of the controller 100 that controls the operation of the fixing device 13 are an example of the fixing device defined in CLAIMS.

In a document reading operation performed by the image forming apparatus 1, under the control of the controller 100, the image reading device 11 optically reads an image of a sheet of original document conveyed by the document conveyance device 6 or an image of a sheet of original document placed on the platen glass 7 and generates image data from the read image. The image data generated by the document reading device 11 is saved in the image memory 20.

In an image forming operation performed by the image forming apparatus 1, under the control of the controller 100, the image processing device 19 applies image processing to image data generated by the above image reading operation and saved in the image memory 20, image data stored in the storage device 18, image data received from a computer connected via the network or other image data and the image forming device 12 forms, based on the image data subjected to the image processing by the image processing device 19, a toner image on a sheet P fed from the sheet feed device 14. Under the control of the controller 100, the fixing device 13 applies heat and pressure to the sheet P with the toner image formed thereon, thus fixing the toner image onto the sheet P. The sheet P after the completion of the fixing processing is ejected to the sheet output tray 8.

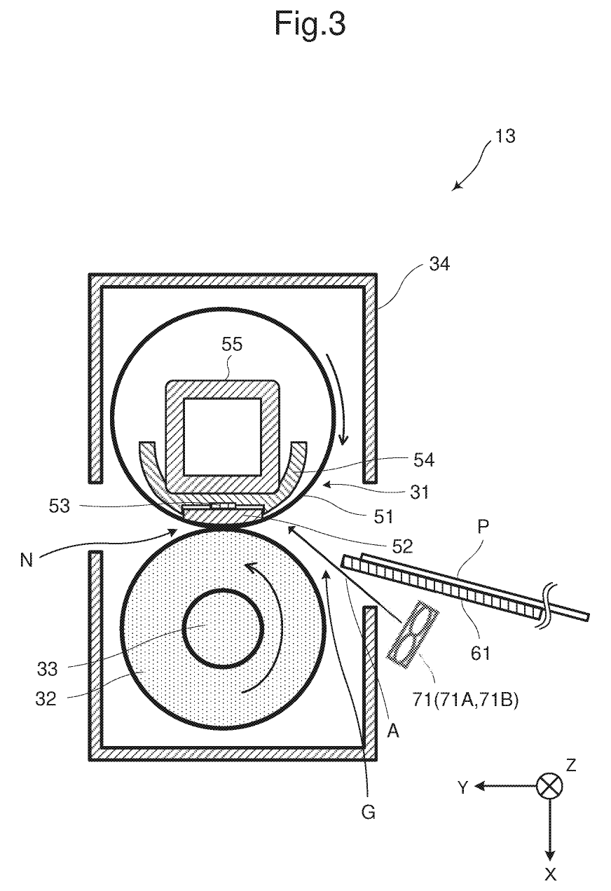

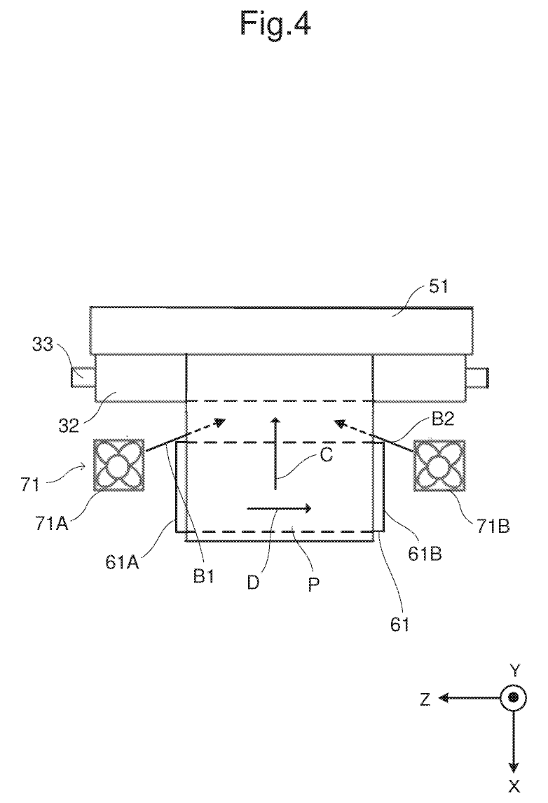

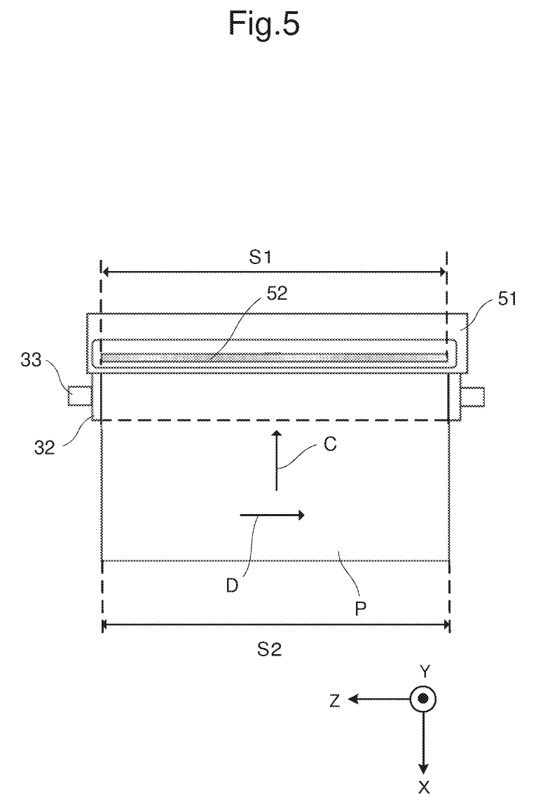

FIG. 3 is a cross-sectional view showing the structure of the fixing device 13 shown in FIGS. 1 and 2. FIG. 4 is a schematic view showing the structure of the fixing device 13 shown in FIG. 3. FIG. 5 is a schematic view showing the size of a heating device 52 included in the fixing device 13 shown in FIG. 3.

The fixing device 13 includes a heat roller 31, a pressure roller 32, a housing 34, and a rotational drive device 41 (see FIG. 2). The heat roller 31 and the pressure roller 32 are contained in the housing 34 made of resin.

The pressure roller 32 is constructed, for example, by providing an elastic layer made of silicon rubber around an iron core and coating the outer periphery of the elastic layer with a 50 μm thick PTA resin film. The pressure roller 32 is journaled within the housing 34 counterclockwise rotatably in the plane of FIG. 3. In the fixing processing, under the control of the controller 100, a rotating shaft 33 of the pressure roller 32 is driven into rotation by the rotational drive device 41 constituted by a motor or the like. The pressure roller 32 is opposed to the heat roller 31 (specifically, a heating member 51 included in the heat roller 31) and forms, together with the heat roller 31 (specifically, the heating member 51 included in the heat roller 31), a nip N where a sheet P to be subjected to the fixing processing is to be passed through. The heat roller 31 and the pressure roller 32 fix a toner image on the sheet P passed through the nip N.

The heat roller 31 includes the heating member 51 having a cylindrical belt-like shape, and a heating device 52, a temperature sensor 53, a holding member 54, a pressing member 55, and so on which are disposed within the heating member 51.

The heating member 51 is formed, for example, by coating the inner and outer surfaces of a 30 mm outside diameter, 0.03 mm thick stainless steel belt with fluorine resin. The heating member 51 is journaled within the housing 34 clockwise rotatably in the plane of FIG. 3. The heating member 51 is pressed against the pressure roller 32 by the pressing member 55 formed of a heat-resistant resin pad and is rotated together with the rotation of the pressure roller 32.

The heating device 52 is, for example, a ceramic heater that is disposed inside the heat roller 31 to heat the heat roller 31. More specifically, the heating device 52 is disposed on the inside of the heating member 51, opposed to the inner periphery of the heating member 51, and heats the inner periphery of the heating member 51. Under the control of the controller 100, the heating device 52 performs a heating operation during the fixing processing and stops it after the completion of the fixing processing.

The holding member 54 holds the heating device 52. For example, the holding member 54 holds the heating device 52 in a manner to accommodate the heating device 52 in an accommodation recess having a size capable of accommodating the heating device 52.

The temperature sensor 53 is, for example, a thermistor, faces the heating device 52, detects the temperature of the heating device 52, and outputs to the controller 100 a detection signal indicating the temperature value of the heating device 52. The temperature sensor 53 is inserted into a groove formed in the holding member 54 to pass through the holding member 54 and abuts on the heating device 52.

The fixing device 13 further includes a conveyance guide 61. The conveyance guide 61 has, for example, a flat-plate shape, is a guide that guides to the nip N a sheet P being conveyed from the conveyance path T toward the fixing device 13, and is provided with a gap G from the pressure roller 32 in a direction of guidance of the sheet P.

The fixing device 13 further includes an air blower 71.

The air blower 71 is, for example, a fan and includes a blowing element 71A and a blowing element 71B. The one blowing element 71A is disposed, as shown in FIG. 3, in a region located on the pressure roller 32 side of the conveyance guide 61 in a direction of alignment of the heat roller 31 and the pressure roller 32 and, as shown in FIG. 4, laterally to one end 61A of the conveyance guide 61 in an orthogonal direction (the direction shown by the arrow D in FIG. 4) orthogonal to a direction in which the conveyance guide 61 guides a recording medium, such as a sheet P (the direction shown by the arrow C in FIG. 4). On the other hand, the other blowing element 71B is disposed, as shown in FIG. 3, in the region located on the pressure roller 32 side of the conveyance guide 61 in the direction of alignment of the heat roller 31 and the pressure roller 32 and, as shown in FIG. 4, laterally to the other end 61B of the conveyance guide 61 in the orthogonal direction (the direction shown by the arrow D in FIG. 4) orthogonal to the direction in which the conveyance guide 61 guides a recording medium, such as a sheet P (the direction shown by the arrow C in FIG. 4).

In other words, the blowing elements 71A, 71B are disposed in one of two regions partitioned by a plane containing the surface of the conveyance guide 61 facing the sheet P to be subjected to the fixing processing and the opposite surface thereof, the one region to which the pressure roller 32 is located closer. In still other words, when the surface of the conveyance guide 61 facing the sheet P to be subjected to the fixing processing and the opposite surface thereof are viewed from a direction normal to the opposite surface, the areas not overlapping with the opposite surface and lateral to both ends 61A, 61B of the conveyance guide 61 are areas where the blowing elements 71A, 71B are disposed.

The blowing elements 71A, 71B blow air, as shown in FIG. 3, through the gap G between the pressure roller 32 and the conveyance guide 61 toward the heat roller 31, specifically, toward the heating member 51 included in the heat roller 31 (in the direction shown by the arrow A in FIG. 3) and, as shown in FIG. 4, in the direction shown by the arrows B1 and B2 in FIG. 4, specifically, toward the center of the conveyance guide 61 in the orthogonal direction (the direction shown by the arrow D in FIG. 4) orthogonal to the direction in which the conveyance guide 61 guides a recording medium, such as a sheet P (the direction shown by the arrow C in FIG. 4). The air blower 71 is provided to make the range of air blowing in the above orthogonal direction a predetermined length not less than the length of the heating device 52 in the orthogonal direction. Specifically, the two blowing elements 71A, 71B are provided to make the total range of air blowing consisting of the respective ranges of air blowing of the two blowing elements 71A, 71B in the orthogonal direction the predetermined length not less than the length of the heating device 52 in the orthogonal direction.

Since each of the blowing elements 71 blows air through the gap G between the pressure roller 32 and the conveyance guide 61 toward the heat roller 32, the recording medium, such as a sheet P, on the conveyance guide 61 acts as a windbreak against the air toward a sheet passing region of the heat roller 31 (a region thereof where the recording medium, such as a sheet P, passes on) to prevent the sheet passing region of the heat roller 31 from being exposed to the air blown from the air blower 71. Furthermore, the recording medium, such as a sheet P, does not act as a windbreak against the air toward non-sheet-passing regions of the heat roller 31 (regions thereof where the recording medium does not pass on) and, thus, the non-sheet-passing regions of the heat roller 31 are exposed to the air blown from the air blower 71.

Since each of the blowing elements 71 blows air toward the center of the conveyance guide 61 in the above orthogonal direction, the air from the air blower 71 can be efficiently blown onto portions of the non-sheet-passing regions of the heat roller 31 near to the sheet passing region thereof.

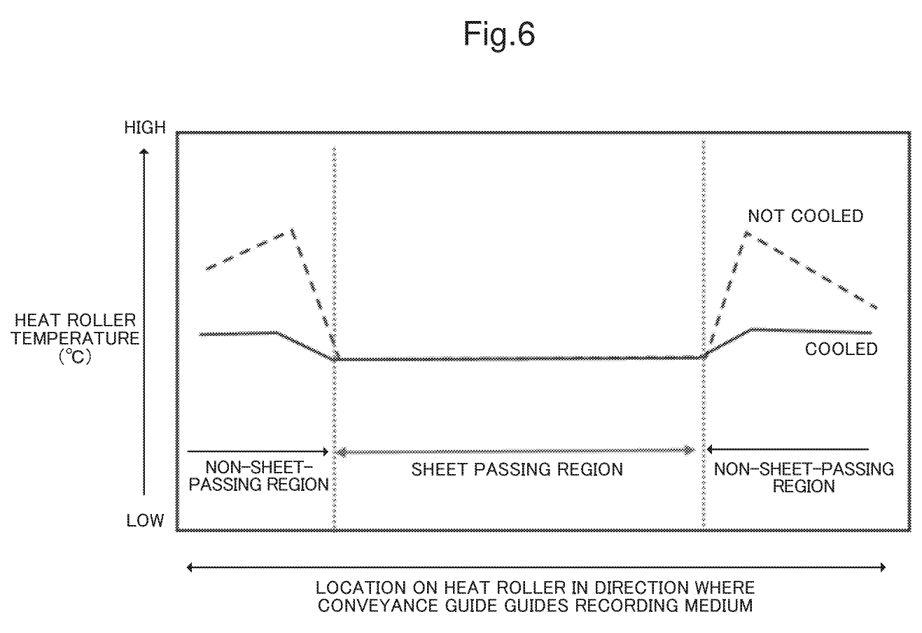

FIG. 6 shows a comparison, based on the arrangement and air-blowing directions of the blowing elements 71 as described thus far, between a temperature distribution of the heat roller 31 when air is blown from the air blower 71 ("Cooled" in FIG. 6) and a temperature distribution of the heat roller 31 when no air is blown from the air blower 71 ("Not Cooled" in FIG. 6). Both the temperature distributions show that they were approximately equal to each other in terms of the temperature at the sheet passing region where the recording medium acted as a windbreak. The temperature of the heat roller 31 dropped at the non-sheet-passing regions in which the recording medium did not act as a windbreak and which were exposed to the air from the blowing elements 71, and significantly dropped at portions of the non-sheet-passing regions located near to the sheet passing region and efficiently exposed to the air from the blowing elements 71.

As shown in FIG. 5, the heating device 52 is provided to match its size S1 in the orthogonal direction (the direction shown by the arrow D in FIG. 5) orthogonal to the direction in which the conveyance guide 61 guides a recording medium, such as a sheet P (the direction shown by the arrow C in FIG. 5) with the size S2 of a predetermined recording medium, such as a sheet P, in the orthogonal direction (the direction shown by the arrow D in FIG. 5). In this embodiment, the heating device 52 having the size S1 approximately equal to the size S2 of the recording medium is used in the fixing device 13. The predetermined recording medium, such as a sheet P, is a recording medium of size expected to be frequently used.

When the size of a sheet P to be subjected to the fixing processing in the orthogonal direction orthogonal to the direction in which the conveyance guide 61 guides a recording medium, such as a sheet P (the direction shown by the arrow C in FIG. 5) is not less than the length S1 of the heating device 52 in the orthogonal direction, the controller 100 keeps the air blower 71 from doing the air blowing operation. When the size of a sheet P to be subjected to the fixing processing in the orthogonal direction is less than the length S1 of the heating device 52 in the orthogonal direction, the controller 100 allows the air blower 71 to do the air blowing operation. In other words, when the size of a recording medium, such as a sheet P, to be subjected to the fixing processing (a recording medium that passes through the nip N formed by the heat roller 31 and the pressure roller 32) in the orthogonal direction orthogonal to the direction in which the conveyance guide 61 guides a recording medium, such as a sheet P, is not less than the length S1 of the heating device 52 in the orthogonal direction, the air blower 71 does not perform the air blowing operation under the control of the controller 100. On the other hand, when the size of a recording medium, such as a sheet P, to be subjected to the fixing processing in the orthogonal direction orthogonal to the direction in which the conveyance guide 61 guides a recording medium, such as a sheet P, is less than the length S1 of the heating device 52, the air blower 71 performs the air blowing operation under the control of the controller 100.

Hereinafter, a description will be given of the control of the controller 100 over the fixing device 13 described above. The controller 100 drives the heating device 52 in PID (proportional-integral-differential) control, for example, to allow the detection temperature of the temperature sensor 53 to reach a predetermined target temperature. When the controller 100 allows the heating device 52 to be supplied with electric power and the detection temperature of the temperature sensor 53 increases beyond the target temperature, the controller 100 decreases the amount of power supplied to the heating device 52. When, thereafter, the detection temperature decreases to less than the target temperature, the controller 100 increases the amount of power supplied to the heating device 52.

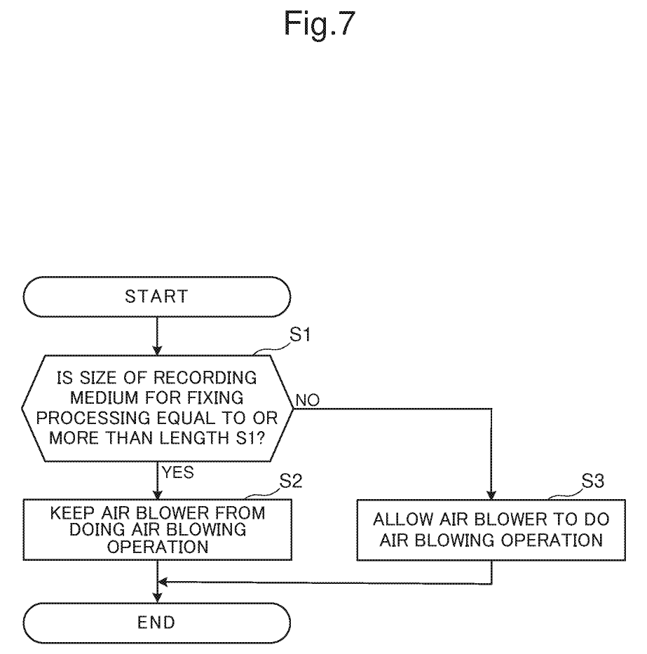

FIG. 7 is a flowchart showing control processing of the controller 100.

The controller 100 determines, based on the settings for printing, whether or not the size of a recording medium, such as a sheet P, to be subjected to the fixing processing in the orthogonal direction orthogonal to the direction in which the conveyance guide 61 guides a recording medium, such as a sheet P, is equal to or more than the length S1 of the heating device 52 in the orthogonal direction (step S1).

When in the determination processing in step S1 the controller 100 determines that the size of a recording medium, such as a sheet P, to be subjected to the fixing processing is equal to or more than the length S1 (YES in S1), the controller 100 determines to avoid the air blowing operation of the air blower 71 and keeps the air blower 71 from doing the air blowing operation (step S2).

When in the determination processing in step S1 the controller 100 determines that the size of a recording medium, such as a sheet P, to be subjected to the fixing processing is less than the length S1 (NO in S1), the controller 100 determines to implement the air blowing operation of the air blower 71 and allows the air blower 71 to do the air blowing operation (step S3).

In the above embodiment, the blowing elements 71A, 71B included in the air blower 71 are disposed in a region located on the pressure roller 32 side of the conveyance guide 61 in the direction of alignment of the heat roller 31 and the pressure roller 32 and blow air toward the heating member 51 through the gap G between the pressure roller 32 and the conveyance guide 61. Thus, the recording medium on the conveyance guide 61 can act as a windbreak against the air toward the sheet passing region of the heat roller 31 to prevent the air blown from the air blower 71 from cooling the sheet passing region, and concurrently the air blown from the air blower 71 can pass through the gap between the pressure roller 32 and the conveyance guide 61 and then blow onto the non-sheet-passing regions of the heat roller 31 to suppress the temperature increase of the non-sheet-passing regions. Suppressing the temperature increase in the non-sheet-passing regions of the heat roller 31 while preventing the sheet passing region of the heat roller 31 from being cooled in the above manner can be implemented by the fixing device 13 with a simple structure in which the blowing elements 71A, 71B are disposed in a region located on the pressure roller 32 side of the conveyance guide 61 in the direction of alignment of the heat roller 31 and the pressure roller 32 and blow air toward the heat roller 31 through the gap G between the pressure roller 32 and the conveyance guide 61.

Furthermore, one blowing element 71A is disposed laterally to one end 61A of the conveyance guide 61 in the orthogonal direction orthogonal to the direction in which the conveyance guide 61 guides a recording medium and blows air toward the center of the conveyance guide 61 in the orthogonal direction, while the other blowing element 71B is disposed laterally to the other end 61B of the conveyance guide 61 in the orthogonal direction orthogonal to the direction in which the conveyance guide 61 guides a recording medium and blows air toward the center of the conveyance guide 61 in the orthogonal direction. Thus, the air from the air blower 71 can blow onto portions of the non-sheet-passing regions of the heat roller 31 located near to the sheet passing region thereof and most liable to increase the temperature and, therefore, an excessive temperature increase in the heat roller 31 can be prevented.

Moreover, the range of air blowing of the air blower 71 in the orthogonal direction orthogonal to the direction in which the conveyance guide 61 guides a recording medium (i.e., the total range of air blowing consisting of the respective ranges of air blowing of the two blowing elements 71A, 71B in the orthogonal direction) is provided to be not less than the length of the heating device 52 in the orthogonal direction. Therefore, even when a recording medium having a small size less than the length S1 of the heating device 52 in the orthogonal direction is conveyed, the non-sheet-passing regions of the heat roller 31 can be cooled.

When the size of a recording medium, such as a sheet P, to be subjected to the fixing processing in the orthogonal direction orthogonal to the direction in which the conveyance guide 61 guides a recording medium, such as a sheet P, is not less than the length S1 of the heating device 52 in the orthogonal direction, the heating device 52 does not exist at locations corresponding to the non-sheet-passing regions of the heat roller 31 and, therefore, the non-sheet-passing regions of the heat roller 31 need not be cooled. However, when the size of a recording medium, such as a sheet P, to be subjected to the fixing processing in the orthogonal direction is less than the length S1 of the heating device 52 in the orthogonal direction, the heating device 52 exists at locations corresponding to the non-sheet-passing regions of the heat roller 31 and, therefore, the non-sheet-passing regions of the heat roller 31 needs to be cooled. In the former case, the air blower 71 is kept from doing the air blowing operation. Only in the latter case, the air blower 71 is allowed to do the air blowing operation. Thus, the power consumption of the fixing device 13 can be reduced.

In the end temperature-increase cooling device described previously, the air blowing width of each air blow port is adjusted by the associated duct shutter in order to suppress the temperature increase in the non-sheet-passing regions of the heat roller while preventing the sheet passing region of the heat roller from being cooled. Therefore, the components of the duct shutters and so on complicate the structure of the end temperature-increase cooling device.

In the present disclosure, suppressing the temperature increase in the non-sheet-passing regions of the heat roller while preventing the sheet passing region of the heat roller from being cooled can be implemented by the fixing device having a simple structure.

The present disclosure is not limited to the structure and processing in the above embodiment and can be modified in various ways. The structure and processing described in the above embodiment with reference to FIGS. 1 to 7 are merely illustrative and are not intended to limit the present disclosure to them.

While the present disclosure has been described in detail with reference to the embodiments thereof, it would be apparent to those skilled in the art that the various changes and modifications may be made therein within the scope defined by the appended claims.

What is claimed is:

1. A fixing device comprising:
a heat roller;
a heating device included in the heat roller and disposed inside the heat roller to heat the heat roller;
a pressure roller that is opposed to the heat roller and forms, together with the heat roller, a nip where a recording medium to be subjected to fixing processing is to be passed through;
a conveyance guide that guides the recording medium to the nip and is provided with a gap from the pressure roller in a direction in which the conveyance guide guides the recording medium; and
an air blower that is disposed in a region located on the pressure roller side of the conveyance guide in a direction of alignment of the heat roller and the pressure roller and blows air toward the heat roller through the gap between the pressure roller and the conveyance guide.

2. The fixing device according to claim 1, wherein the air blower is disposed laterally to both ends of the conveyance guide in an orthogonal direction orthogonal to the direction in which the conveyance guide guides the recording medium and the air blower blows air toward a center of the conveyance guide in the orthogonal direction.

3. The fixing device according to claim 2, wherein the air blower comprises: a first blowing element disposed laterally to one of both the ends of the conveyance guide; and a second blowing element disposed laterally to the other of both the ends of the conveyance guide.

4. The fixing device according to claim 1, wherein
the heat roller comprises a heating member having a cylindrical belt-like shape, and
the heating device is disposed on an inside of the heating member and heats an inner periphery of the heating member.

5. The fixing device according to claim 1,
further comprising a control device that includes a processor and functions, through the processor executing a control program, as a controller that drives and controls an air blowing operation of the air blower,
wherein when a size of the recording medium to be subjected to the fixing processing in the orthogonal direction is not less than a length of the heating device in the orthogonal direction, the controller keeps the air blower from doing the air blowing operation, and
when the size of the recording medium to be subjected to the fixing processing in the orthogonal direction is less than the length of the heating device in the orthogonal direction, the controller allows the air blower to do the air blowing operation.

6. The fixing device according to claim 1, wherein the air blower is provided to make a range of air blowing in the orthogonal direction a predetermined length not less than a length of the heating device in the orthogonal direction.

7. An image forming apparatus comprising:
an image forming device that forms a toner image; and
the fixing device according to claim 1, the fixing device fixing the toner image formed by the image forming device onto a surface of the recording medium.
